(19) United States
(12) Patent Application Publication
(10) Pub. No.: US 2013/0034061 A1
(43) Pub. Date: Feb. 7, 2013

(54) REVERSE DIRECTION PROTOCOL IMPLEMENTATION

(71) Applicants: Hongyu Xie, San Diego, CA (US); Gang Lu, Pleasanton, CA (US); Yuan Zhuang, San Diego, CA (US); Brima Ibrahim, Laguna Hills, CA (US); Shawn Shiliang Ding, San Diego, CA (US); Payam Torab Jahromi, Laguna Niguel, CA (US)

(72) Inventors: Hongyu Xie, San Diego, CA (US); Gang Lu, Pleasanton, CA (US); Yuan Zhuang, San Diego, CA (US); Brima Ibrahim, Laguna Hills, CA (US); Shawn Shiliang Ding, San Diego, CA (US); Payam Torab Jahromi, Laguna Niguel, CA (US)

(73) Assignee: Broadcom Corporation, Irvine, CA (US)

(21) Appl. No.: 13/196,610

(22) Filed: Aug. 2, 2011

(51) Int. Cl. H04W 72/04

(52) U.S. Cl. 370/329

(57) ABSTRACT

A responder endpoint establishes a reverse direction communication channel from the responder to an initiator. To that end, the responder endpoint receives a reverse direction grant indicator and determines when primary data is not ready to be sent to the initiator. In response, the responder transmits to the initiator, within a predetermined response time for establishing the reverse direction communication channel, a continuation frame comprising a continuation indicator that indicates that reverse direction communication channel should persist. In one implementation, the continuation frame includes at least one control field including the continuation indicator, but no data payload field.

### BACKGROUND

1. Technical Field

This disclosure relates to communication protocols. In particular, this disclosure relates to an implementation of the reverse direction protocol for wireless communications.

2. Related Art

Continual development and rapid improvement in wireless communications technology have lead the way to increased data rates and broad wireless functionality in many different environments, including the home and business environments. These developments and improvements have been driven in part by the widespread adoption of digital media, including high definition video and music. The most recent developments in wireless connectivity promise new functionality and data rates far exceeding rates that the 802.11n and the 802.11TGac standards provide. These recent developments include the Wireless Gigabit Alliance (WiGig) 60 GHz wireless specification.

The WiGig specification provides data transmission rates of up to 7 Gbps in a single stream, which is more than 10 times faster than the highest data rate that the 802.11n multiple input mulitple output (MIMO) standard supports. At the same time, the WiGig specification implements backward compatibility with the 802.11 standard. Another benefit of the WiGig specification is that devices in the 60 GHz ecosystem will have the bandwidth to wirelessly communicate significant amounts of information without performance compromises, thereby eliminating the current need for tangles of cables to physically connect devices. WiGig devices may, for example, wirelessly stream high definition video content directly from a Blu-Ray player to a TV with little or no compression required.

The WiGig specification has adopted the reverse direction (RD) protocol that was originally specified in the 802.11n specification for contention based Transmit Opportunities (TXOPs), and has extended the RD protocol to allocation/contention free based Service Periods (SPs) that are defined in the WiGig specification. During a TXOP or SP, the default data flow is from the SP owner or TXOP holder to the SP destination or TXOP responder respectively, namely the forward direction. However, in many high quality of service (QoS) applications, immediate reverse direction data flow is very useful (i.e., data flow from the SP destination or TXOP responder back to the SP owner or TXOP holder respectively). In these cases, the SP owner or TXOP holder may initiate (as the RD initiator) one or more reverse direction grants (RDGs) for a specified maximum duration to potentially responding devices along with the data packets in the forward direction to give the peer device a chance to respond back with its data packets. The RD responder may accept the grant and then communicate data, if any is available, back to the RD initiator. The RD protocol provides a flexible, low latency, reverse direction communication channel that is also efficient because it does not incur the channel access and TXOP/SP scheduling overhead.

The WiGig specification, however, mandates far more challenging response times by an RD responder. Essentially, the RD responder must begin to transmit its sequence of data packets back to the RD initiator within the Short Interframe Spacing (SIFS) time if no acknowledgement is required for the data in the forward direction. The RD responder must also indicate whenever more data will follow by setting the MorePPDU bit field to 1. In the WiGig specification, the SIFS period is 3 μs (3 microseconds), compared with the much more generous 16 μs allowed in 802.11n.

Under the 802.11 standard, a “control wrapper frame” allows any control frame to be returned inside of (wrapped in) the control wrapper frame. The control frames wrapped in the control wrapper frame may include acknowledgement frames or block acknowledgement frames. The control wrapper frame also adds a High Throughput (HT) control field that includes the MorePPDU bit field. Accordingly, the RD responder may send a control wrapper frame and inform the RD initiator that the RD responder has more data to return by setting MorePPDU to 1 in the HT control field. Alternatively, the RD responder may inform the RD initiator that there is no more data to return by setting MorePPDU to 0. Using the control wrapper frame for this purpose, however, incurs the overhead of transmission of another control frame wrapped inside the control wrapper frame.

The WiGig specification does not support the control wrapper frame. The WiGig specification thereby eliminates one mechanism for informing the RD initiator that more data will be communicated to it over the reverse direction channel. In general, devices in the WiGig ecosystem face significant challenges in responding quickly enough (within the 3 μs SIFS time) to take advantage of the significant benefits of the RD protocol.

### BRIEF DESCRIPTION OF THE DRAWINGS

The system may be better understood with reference to the following drawings and description. In the figures, like reference numerals designate corresponding parts throughout the different views.

FIG. 1 shows an environment in which wireless endpoints communicate with one another.

FIG. 2 shows a reverse direction grant initiator communicating with a reverse direction grant responder.

FIG. 3 shows a communication diagram for reverse direction protocol communication between a reverse direction grant initiator and a reverse direction grant responder.

FIG. 4 shows a QoS Null frame and a QoS data frame.

FIG. 5 shows a communication diagram for reverse direction protocol communication between a reverse direction grant initiator and a reverse direction grant responder.

FIG. 6 shows a communication diagram for reverse direction protocol communication between a reverse direction grant initiator and a reverse direction grant responder.

FIG. 7 shows an example of an endpoint.

FIG. 8 shows a flow diagram of logic for implementing a reverse direction grant protocol.

### DETAILED DESCRIPTION

This description relates to the reverse direction protocol under standards such as the IEEE 802.11 standards or the WiGig standards, including the 60 GHz wireless specification promoted by the Wireless Gigabit Alliance and the IEEE 802.11TGad standard. Accordingly, the discussion below makes reference to reverse direction (RD) initiators and responders. The RD initiators and RD responders implement a reverse direction (RD) protocol that permits an RD responder to transmit data back to the RD initiator, even though the RD initiator presently owns the current transmission opportunity (TXOP) or Service Period (SP). The RD initiators and RD responders may be endpoints that communicate wirelessly or over physical connections.

The endpoints, and therefore the RD initiators and RD responders, may take many different forms. As examples, the endpoints may be cell phones, smart phones, laptop computers, personal data assistants, pocket computers, tablet computers, portable email devices, people or pets, or processes or threads executed in memory by a processor. Additional examples of endpoints include televisions, stereo equipment such as amplifiers, pre-amplifiers, and tuners, home media devices such as compact disc (CD)/digital versatile disc (DVD) players, portable MP3 players, high definition (e.g., Blu-Ray (™) or DVD audio) media players, or home media servers. Other examples of endpoints include musical instruments, microphones, climate control systems, intrusion alarms, audio/video surveillance or security equipment, video games, network attached storage, network routers and gateways, pet tracking collars, or other devices.

Endpoints may be found in virtually any context, including the home, business, public spaces, or automobile. Thus, as additional examples, endpoints may further include automobile audio head ends or DVD players, satellite music transceivers, noise cancellation systems, voice recognition systems, climate control systems, navigation systems, alarm systems, engine computer systems, or other devices.

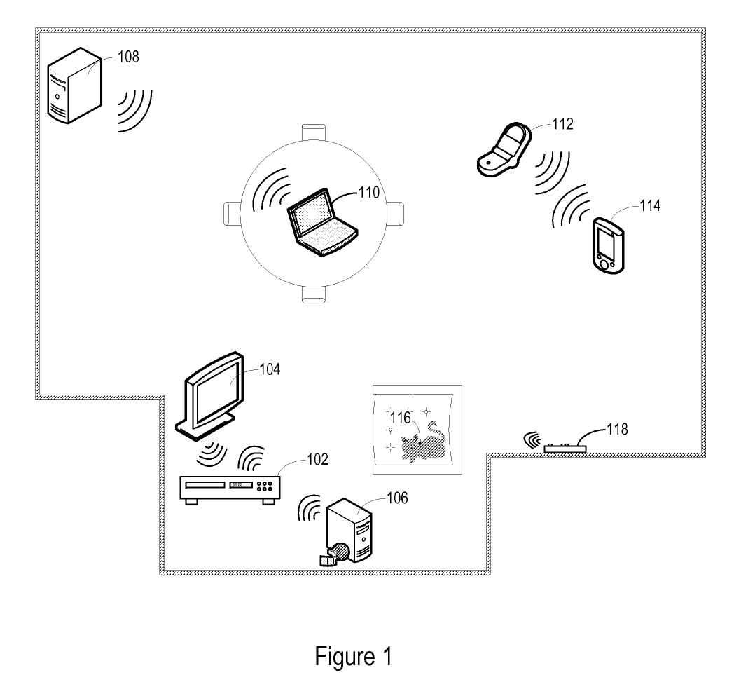

FIG. 1 shows one example of an environment 100 in which wireless endpoints communicate with one another. In this example, the environment 100 is a room in a home. The environment 100 includes multiple endpoints that communicate wirelessly with the other endpoints. In FIG. 1, a media player 102 (e.g., a Blu-Ray (™)) streams high definition video and audio content to a high definition liquid crystal display (LCD) television (TV) 104. Similarly, a home media server 106 with a wireless network interface streams audio (e.g., MP3 content) and video (e.g., MP4, AVI, or MPEG content) to other endpoints in the environment 100.

Other examples of endpoints in the environment 100 include the application and file server 108 that is in communication with the laptop computer 110. FIG. 1 also shows a smartphone 112 and a portable gaming system 114 wirelessly exchanging information (e.g., text messages or video game saved game files), as well as a pet tracking collar 116 in communication with a house monitoring system 118 that helps locate the elusive house cat. Other endpoints may exist in the environment, and different environments may include additional, fewer, or different endpoints.

The endpoints may communicate wirelessly using the 802.11a/b/g/n/ac standards, according to the WiGig 60 GHz specification, or according to other wireless standards. In some cases, such as with the WiGig or 802.11n/ac standards, the endpoints are allocated SPs or obtain TXOPs by winning the channel access contention during which they are entitled to specific windows of time to transmit information without other endpoints attempting to access the channel. Furthermore, the endpoints may implement a RD protocol that permits a RD initiator to grant a RD responder the opportunity to transmit data back to the RD initiator during the RD initiator's TXOP or SP. A specific example will be provided below with respect to the TV 104 and the media player 102 to aid understanding, but it is noted that the techniques described below may be employed as part of a RD protocol in any environment by any of the endpoints for whatever reason the endpoints decide to use a reverse direction channel.

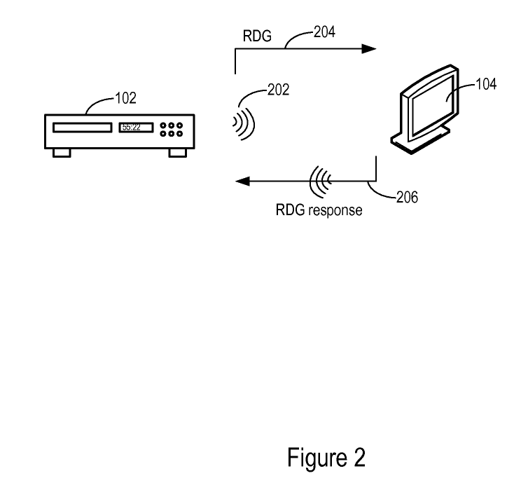

FIG. 2 shows the media player 102 streaming high definition audio/visual content 202 to the TV 104. In doing so, the media player 102 transmits the audio/video content 202 during its SPs or TXOPs to the TV 104. During its SPs or TXOPs, the media player 102 may allow the TV 104 to communicate back to the media player 102. As one example, the media player 102 may allow the reverse direction channel in order to obtain environmental data sensed by the TV 104 that the media player 102 may take into consideration for rendering the audio/visual data communicated to the TV 104. To begin the process of establishing the reverse direction channel, the media player 102 transmits a reverse direction grant (RDG) 204 to the TV 104. The TV 104 sends an acknowledgement of the communication, and if the TV 104 supports RDGs and has data for the media player 102, the TV 104 may send an RDG response 206.

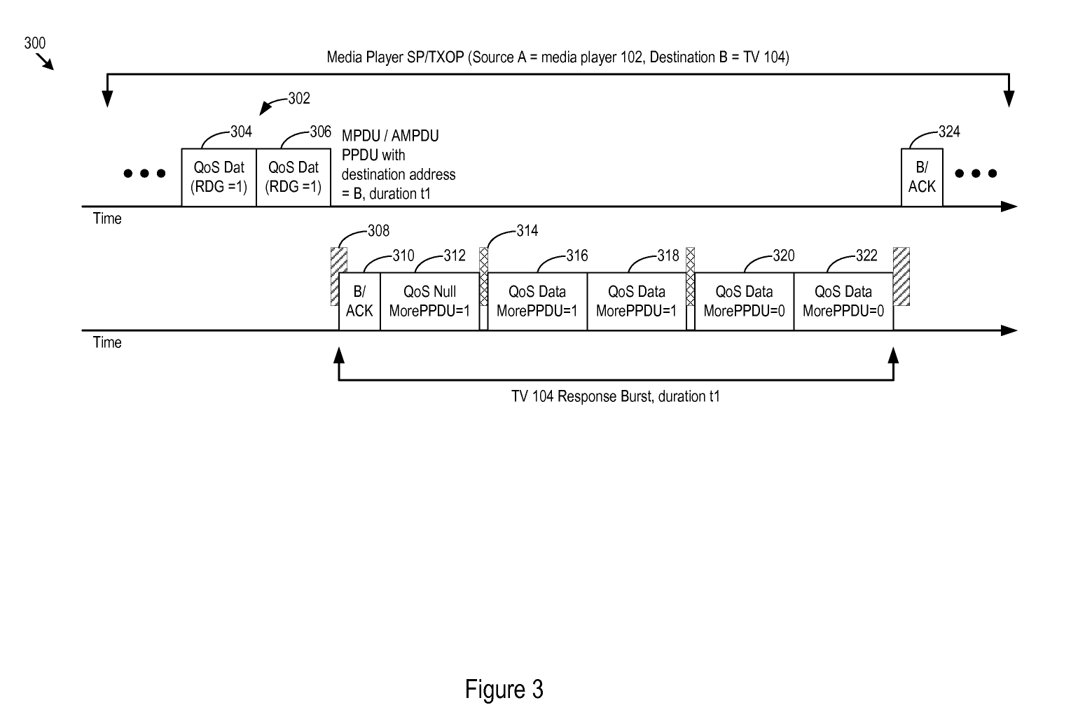

FIG. 3 shows a communication diagram 300 with an example (under the WiGig specification) of a RDG from the media player 102, and the associated RDG response from the TV 104. In particular, the media player 102 transmits an aggregation 302 of QoS Data frames 304 and 306 in which the media player 102 has set the RDG bit to 1. The RD initiator may organize and aggregate the QoS Data frames into media access control (MAC)-level protocol data units (MPDUs) carried by Physical (PHY) layer protocol data units (PPDUs), for example.

Setting the RDG bit to 1 indicates to the destination addressee (e.g., the TV 104) that it has an opportunity to establish a reverse direction communication channel, and that it may accept the RD grant to communicate data back to the RDG initiator (e.g., the media player 102). The RD responder (in this case the TV 104) needs to respond within the SIFS interval 308 (about 3 μs). The TV 104 does so by transmitting an acknowledgement (ACK) or block acknowledgement (BACK) 310, followed by a QoS Null frame 312 with the MorePPDU bit set to 1 to indicate that more data follows.

In particular, within a SIFS or Reduced Interframe Spacing Time (RIFS) 314, the TV 104 sends additional data in (optionally aggregated) QoS Data frames (e.g., the QoS Data frames 316 and 318). The QoS Data frames set MorePPDU to 1 to indicate that the TV 104 has additional data to transmit to the media player 102. The TV 104 continues to send data during its response burst until, as shown by the QoS Data frames 320 and 322, with MorePPDU set to 0, the TV 104 has no further data to transmit back to the media player 102. The media player 102 then transmits an ACK 324 of the response burst from the TV 104 and the RDG ends.

In terms of the response structure shown in FIG. 3, the B/ACK 310 and QoS Null frame 312 may be part of an Aggregated MAC Protocol Data Unit (AMPDU), for example. The QoS Data frames 316 and 318 may be part of an AMPDU with only data aggregation. Such aggregation is optional, and other aggregations may be employed.

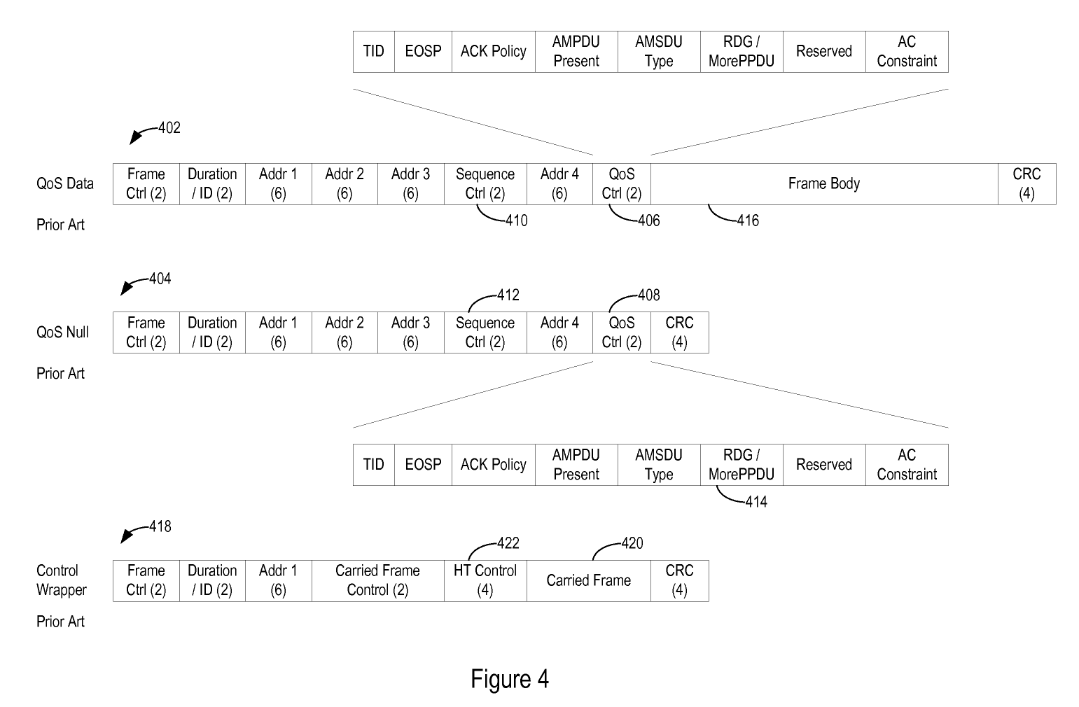

The signaling sequence shown in FIG. 3 demonstrates that the RD initiator transmits a RDG indicator (e.g., a bit field set to 1) to a RD responder. The RD responder receives the RDG indicator and acknowledges reception of the frame containing the RDG indicator. When the RD responder desires to establish the reverse direction channel, the RD responder transmits, in response to the RDG indicator, a continuation frame with a data continuation indicator within the required response time. For example, the RD responder may respond with a QoS Null frame with the MorePPDU bit set to 1 within the SIFS time. For reasons described in more detail below with regard to FIG. 4, transmitting the QoS Null frame allows the RD responder to more easily meet the SIFS time, because no actual data need be ready for the RD initiator at the time that the QoS Null frame is prepared and transmitted. Instead, the RD responder may transmit the QoS Null frame, or a sequence of QoS Null frames, to gain time to obtain the data that the RD responder needs to return to the RD initiator. In that sense, the QoS Null frames operate as placeholders in time and space that provide additional processing time for the RD responder to obtain and transmit the desired data back to the RD initiator in, for example, one or more QoS Data frames.

FIG. 4 shows a QoS Data frame 402 and a QoS Null frame 404. These frame types are defined in the WiGig specification. The QoS Data frame 402 and the QoS Null frame 404 both include control and address information, including QoS control fields (2 octets) 406 and 408 and Sequence Control fields (2 octets) 410 and 412. The QoS Control fields 406 and 408 include a RDG/MorePPDU bit field (e.g., the bit field 414).

The QoS Data frame 402 also includes a frame body field 416 specifically allocated to carry a data payload. To track and account for each data payload that is sent in a QoS Data frame 402, the sequence control field 410 in the QoS Data frame uses, for example, a 12 bit sequence number. The sequence number provides a specific number assigned to data payload in the QoS Data frame. The sequence number may be identical for each frame sent for a fragmented frame. Otherwise, the sequence number is incremented by one until reaching 4095, when it resets to zero.

The sequence control field 410 may also include a 4 bit fragment number. The fragment number sequentially increments to indicate each fragment of a fragmented frame. The sequence control field 410 thereby permits the recipient to understand how any particular data payload fits into the overall data stream that is sent. There is a certain amount of overhead required to track, monitor, count, and maintain the correct sequence and fragment data in the sequence control field 410. In addition, each QoS traffic stream has its own dedicated sequence number generator for the MPDUs carrying data payload belonging to that QoS traffic stream. The sequence number generator for a particular QoS traffic stream is maintained independently from other sequence number generator(s) for their corresponding QoS traffic stream(s) running concurrently.

Note, however, that the frame body field 416 is absent in the QoS Null frame 404. In other words, the QoS Null frame 404 does not carry any data in a specifically defined separate payload field. Therefore, the sequence control field 412 in the QoS Null frame 404 need not be updated and does not reflect any ordering information for data payloads. Again, there is no data payload in the QoS Null frame 404 to track.

Furthermore, the current WiGig specification, as well as the 802.11/a/g/n/ac specifications, do not require the sequence control field 412 to meet any particular content or payload tracking requirements. In other words, the sequence control field in the QoS Null frame 404 can carry any value without violating the specifications. note that, even though the QoS Data frame 402 looks identical to the QoS Null frame 404 when the length of the QoS Data frame's frame body 41 is 0, the sequence number for the zero-length payload QoS data frame is still required under the specifications.

FIG. 4 shows another example in the form of the control wrapper frame 418. The control wrapper frame 418 carries inside of it another control frame 420 (such as an ACK control frame or B/ACK control frame), as well as an HT control field 422. The HT control field 422 includes (at bit 31 in the 802.11n standard) an RDG/MorePPDU bit field, as a mechanism to provide RD protocol support. Note that both the QoS Null frame 404 and QoS Data frame 402 are data frame types, not control frame types. Therefore they cannot be wrapped into a control wrapper frame. The WiGig specification removes the control wrapper frame 418 and the HT control field. In order to still support the RD protocol, the WiGig specification merges RD protocol related sub-fields (such as RDG/MorePPDU) that are located in the HT control field of the control wrapper frame in the 802.11n specification into the QoS control field of QoS Null frame 404 or QoS Data frame 402. Therefore, in the WiGig specification, the QoS Null frame 404 or QoS Data frame 402 are the only frame types that can convey RDG and MorePPDU information. In other words, due to the removal of the control wrapper frame, the ACK or B/ACK control frames under the WiGig specification cannot convey RDG and MorePPDU information because they do not contain the QoS control field where the RDG/MorePPDU bit is defined. Hence, in WiGig, the required ACK or B/ACK control frame has to be aggregated/bundled with either the QoS Null frame 404 or QoS Data frame 402 (to form an AMPDU) in order to indicate to the RD initiator the following RD data. Aggregating the required ACK or B/ACK control frame with QoS Data frame(s) imposes implementation challenges: other than the very short turn around to have the RD data ready, it also requires the mixed-type AMPDU aggregation—namely mixing a control frame type (ACK or B/ACK) with a QoS Data frame type. The techniques described in this document with regard to the QoS Null frame help avoid these potentially significant implementation challenges.

Note that the QoS Null frame 404 does not include a data payload field, need not maintain any tracking requirements over the sequence control field 412, and includes an RDG/MorePPDU data field. Accordingly, the RD responder may very quickly return a QoS Null frame 404 to the RD initiator, with MorePPDU=1, when the RD responder has data to return, but cannot have the data ready within the required SIFS time. The ability to quickly return the QoS Null frame greatly relaxes the hardware and software implementation difficulty. Part of the reason that the difficulty exists is that timely establishing a RD channel requires a response from the RD responder within the SIFS time.

Thus, one technique for establishing a reverse direction communication channel from a RD responder to a RD initiator includes receiving a reverse direction grant indicator at the RD responder, and transmitting from the RD responder to the RD initiator, in response to the reverse direction grant indicator, a continuation frame (e.g. a QoS Null frame) that includes a continuation indicator (e.g., a MorePPDU bit). The continuation indicator determines whether the reverse direction communication channel should persist. The continuation frame includes a control field (e.g., QoS Control 408) that includes the continuation indicator. The continuation frame need not have a data payload field. The RD responder may send the continuation frame when it does want to send data back to the RD initiator, but the data is not ready or available to send. Said another way, the RD responder establishes the reverse direction channel, even when it has no data presently available to send in the channel, or when data is presently available, but the RD responder decides to withhold the data for any reason (e.g., to buffer additional data not yet available before starting to send data back to the RD initiator).

The RD responder may transmit the continuation frame as an initial response to the reverse direction grant indicator. Alternatively, the RD responder may transmit an acknowledgement (ACK) or block ACK frame immediately followed by the continuation frame as the initial response to the reverse direction grant indicator. As noted above, there are no content constraints on the sequence control field 412 in the QoS Null frame 404. Accordingly, the RD responder may use that existing field (or other unused fields), although defined for sequence control purposes (or other purposes), for communicating data or commands from the RD responder to the RD initiator for a different purpose.

In the example above, the TV 104 may, for example, send environmental data (e.g., room brightness) back to the media player 102 in one or more 2-byte sequence control fields 412 in one or more QoS Null frames. Similarly, any type of endpoint may send any type of data or commands back in the reverse direction channel using the sequence control field. Another example is a car engine computer that communicates speed or acceleration data back to the car stereo for noise cancellation purposes or volume adjustment purposes. Yet another example is a portable video game player sending a light dimming command to a home environment controller. Additional examples include setting the sequence control field to indicate how much data is coming from the RD initiator to the RD responder, how much data is queued up at the RD responder, how much buffer is left at the RD responder, and channel conditions (e.g., signal to noise ratio).

Note that the RD responder may continue to send QoS Null frames as long as desired until the specified RD duration expires. Thus, the RD responder may transmit a series of continuation frames with the continuation indicator set, until the RD responder has its data ready to send back to the RD initiator, or until it chooses to start sending data back to the RD initiator. When ready, the RD responder may transmit its data back to the RD initiator using a QoS Data frame and the data payload field provided in the QoS Data frame.

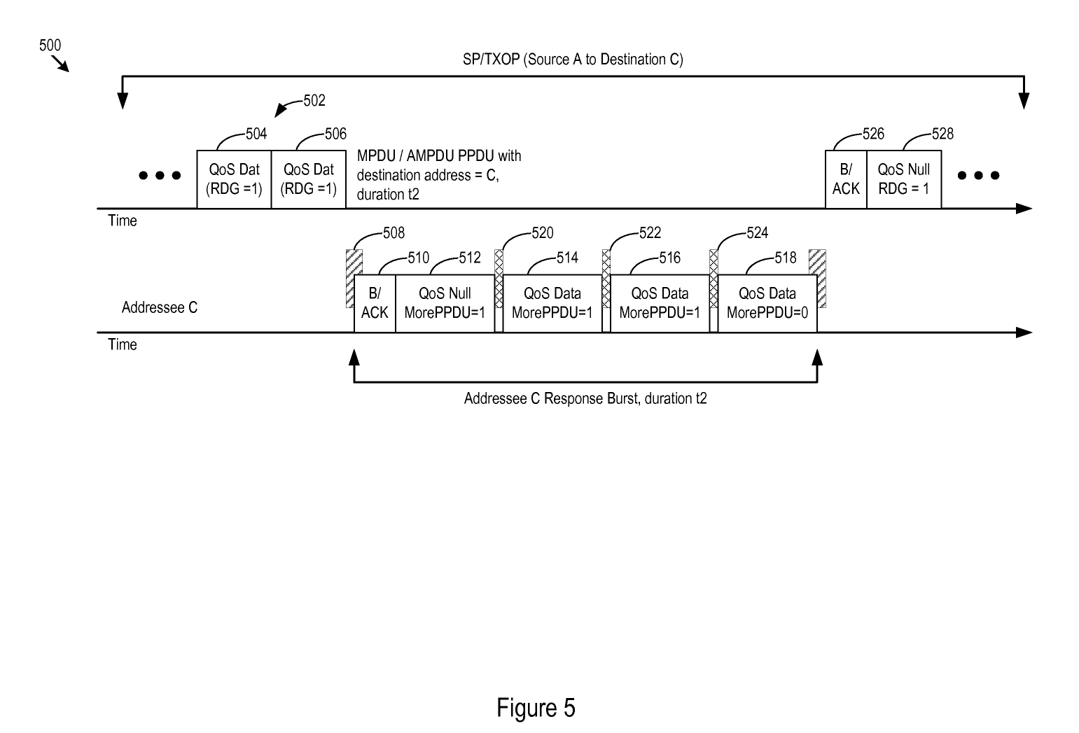

Following on the example of FIG. 3, FIG. 5 shows a communication diagram 500 for reverse direction protocol communication between a reverse direction grant initiator and a reverse direction grant responder. The RD initiator transmits an aggregation 502 of QoS Data frames 504 and 506 in which the RDG bit is set to 1. Setting the RDG bit to 1 indicates to the destination addressee C that it has an opportunity to establish a reverse direction communication channel, and that it may accept the RD grant to communicate data back to the RDG initiator. The RD responder needs to respond within the required response time, namely the SIFS interval 508. In this example, the RD responder does so by transmitting an acknowledgement (ACK) or block acknowledgement (BACK) 510, followed by a QoS Null frame 512 with the MorePPDU bit set to 1 to indicate that the reverse direction channel should be established and that data will follow. Note that the RD responder need not actually provide any data because the QoS Null frame 512 requires none and in fact has no specific field for a data payload. Accordingly, the RD responder may quickly initiate the reverse direction channel even if the RD responder cannot prepare the data for the RD initiator within the stringent SIFS time.

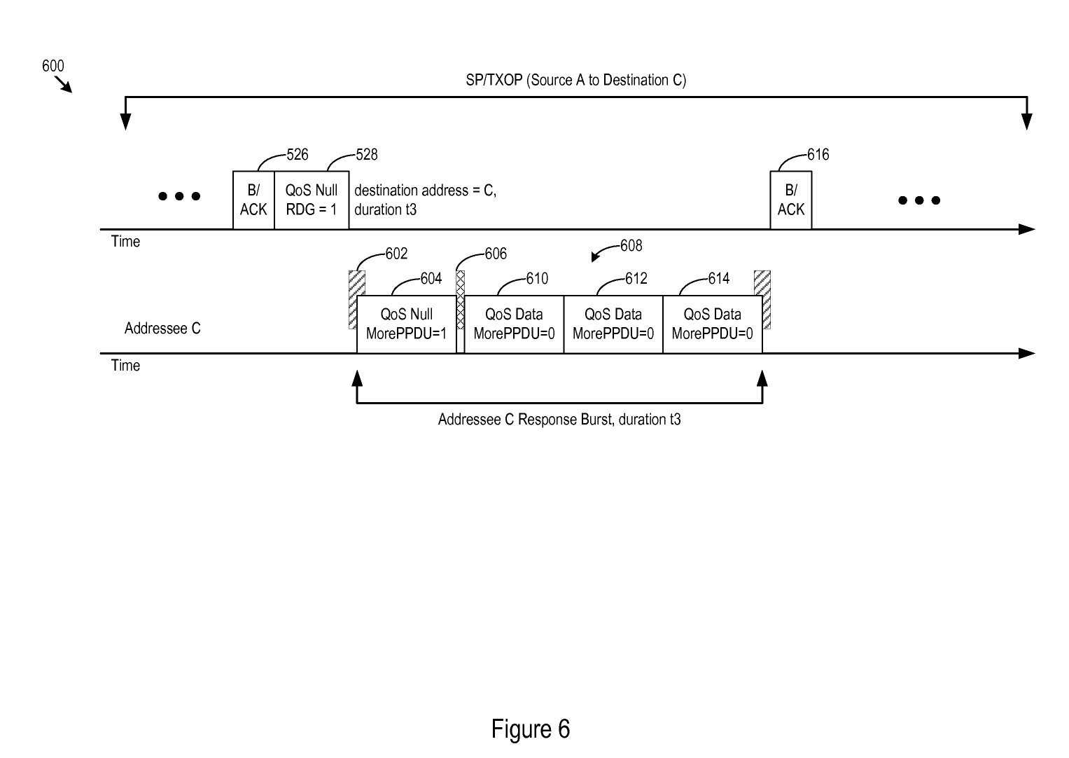

Once the reverse direction channel is established, the RD responder provides data to the RD initiator in a series of QoS Data frames 514, 516, and 518. The QoS Data fames follow in sequence within whatever spacing is required (e.g., within a SIFS/RIFS time 520, 522, 524). When the RD responder has no more data, it sets MorePPDU=0 in the QoS Data frame 518. There may be as many QoS Null or QoS Data frames as the reverse direction grant time allows. In this example, the RD initiator then transmits an ACK 526 of the response burst from RD responder along with a QoS Null frame 528 with RDG=1 in an AMPDU. The reverse direction channel from the RD responder to the RD initiator then terminates. However, the RD initiator immediately signals another opportunity for a reverse direction channel by building and sending the QoS Null frame 528, as described with reference to FIG. 6.

FIG. 6 shows another example of a communication diagram 600 for reverse direction protocol communication between a reverse direction grant initiator and a reverse direction grant responder. The RD initiator transmits the QoS Null frame 528 to signal another opportunity for the RD responder to start a new reverse direction channel. In this example, the RD responder responds within the SIFS time 602 by sending a QoS Null frame 604 with MorePPDU=1 to indicate that more data follows. There is no initial ACK or block ACK from the RD responder in this example. The RD responder thereby establishes the reverse direction channel and keeps it open until the data is ready for the RD initiator.

Once the reverse direction channel is established, the RD responder provides, within the SIFS/RIFS time 606, its data to the RD initiator in an AMPDU 608 (e.g., with only data aggregation). The AMPDU includes the three QoS Data frames 610, 612, and 614. Each of the QoS Data frames 610, 612, 614 has MorePPDU=0 to indicate that no further data is coming from the RD responder.

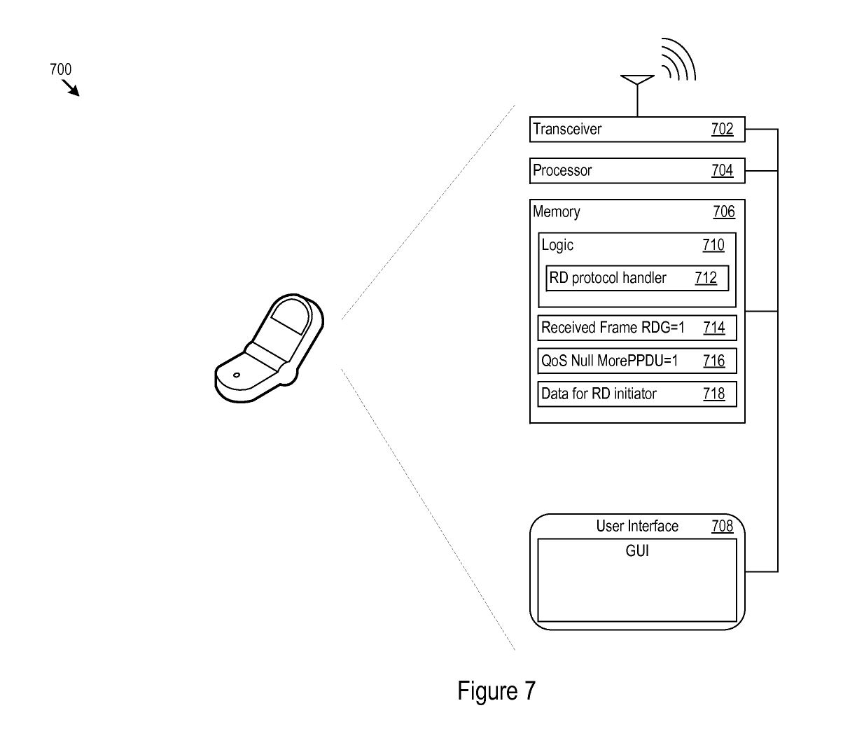

FIG. 7 shows an example of an endpoint 700, in this instance a smartphone. The endpoint 700 includes a transceiver 702, one or more processors 704, a memory 706, and a user interface 708. The transceiver 702 may be wireless transceiver, and the transmitted and received signals may adhere to any of a diverse array of formats, protocols, modulations, frequency channels, bit rates, and encodings that presently or in the future may support reverse direction protocols. Thus, the transceiver 702 may support the 802.11a/b/g/n/ac standards, the 60 GHz WiGig/802.11TGad specification, Bluetooth, Global System for Mobile communications (GSM), Time Division Multiple Access (TDMA), Frequency Division Multiple Access (FDMA), Code Division Multiple Access (CDMA), or other wireless access techniques or protocols.

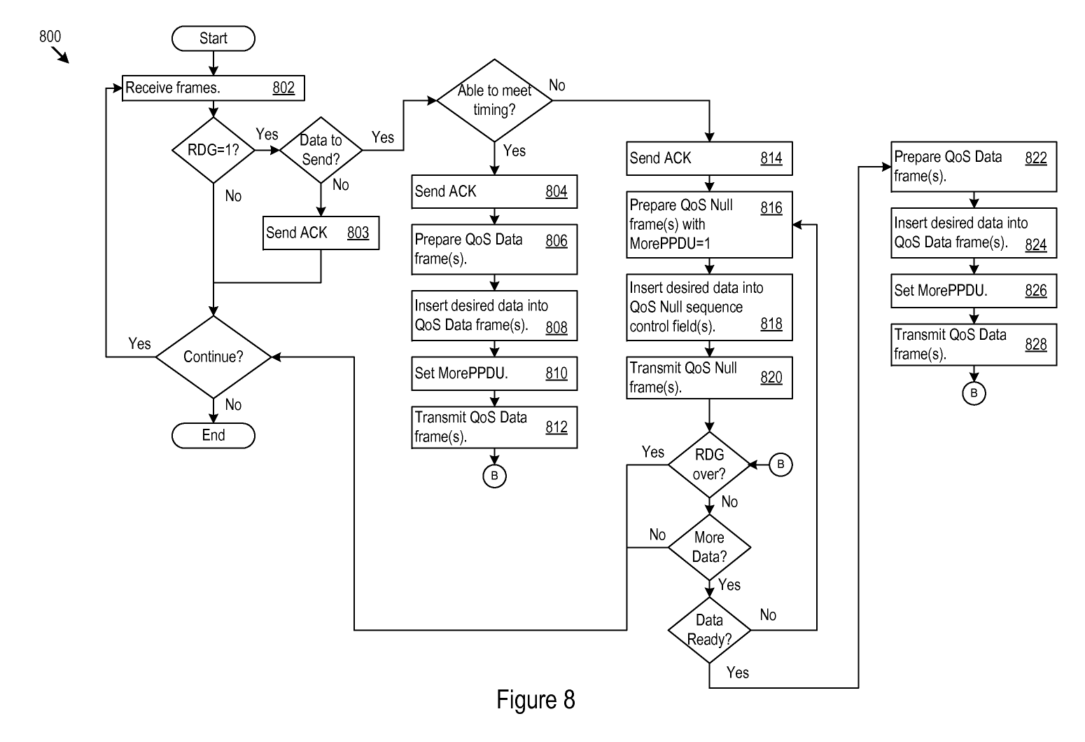

The processor 704 executes the logic 710. The logic 710 may be an operating system, application program, firmware, or other logic. The logic 710 includes an RD protocol handler 712 (or other response logic for handling RDGs). The RD protocol handler 712 may implement the processing noted above with respect to the reverse direction grants, and described below with respect to FIGS. 7 and 8. For example, the RD protocol handler 712 may recognize opportunities for a reverse direction channel, and establishing the channel using, for example, the QoS Null frame response with MorePPDU=1.

To that end, the transceiver 702 stores received frames 714 in the memory 706. The protocol handler 712 may check the received frames 714 for a reverse direction grant indicator (e.g., an RDG field set to 1). As noted above, the endpoint 700 may quickly respond to RDGs using a QoS Null frame 716 with MorePPDU=1, even if the data 718 for the RD initiator is not yet available. When the data 718 becomes available, the endpoint 700 communicates the data 718 to the RD initiator using one or more QoS Data frames, for example. At any time, the endpoint 700 may communicate data back to the RD initiator using data fields that were originally specified for another purpose. For example, the endpoint 700 may send data back to the RD initiator in the sequence control field of a QoS Null frame.

FIG. 8 shows a flow diagram of logic for implementing a reverse direction grant protocol, such as may be implemented in the endpoint 700 under direction of the RD protocol handler 712. The transceiver 702 receives frames that may include a reverse direction grant indicator (802). The processor 704 determines whether the RDG bit is set. If the RDG bit is not set, then the endpoint 700 may continue to receive frames.

However, if the RDG bit is set, then the processor 704 determines whether the endpoint 700 has primary data (e.g., data that is formally tracked through the sequence control field 410 or other sequencing information) to send to the RD initiator. If there is no data to send, then the endpoint 700 may simply acknowledge receipt (803) of the frame containing the RDG, and return to receiving frames (802). When the endpoint 700 has data to send to the RD initiator, however, the processor 704 determines whether the endpoint 700 can respond with the data within the required response time (e.g., the SIFS time). When the endpoint 700 can meet the required response time, then the endpoint may send an ACK or block ACK (804) if the protocol requires one. The endpoint 700 then prepares, for example, QoS Data frames 402 (806) and inserts at least a portion of the data that is ready for the RD initiator into the QoS Data frames (808). The endpoint also sets a continuation bit (e.g., the MorePPDU bit) appropriately (810). For example, when the endpoint 700 has additional data to send, then the processor 704 may set MorePPDU=1; otherwise, the processor may set the MorePPDU bit=0. The transceiver 702 sends the QoS Data frames individually, or aggregated into larger units (e.g., AMPDUs) (812).

Because the required response time may be very short, the endpoint may not always be able to respond with its data in the required response time. In that case, the transceiver 702 may send an ACK (814), and may prepare a QoS Null frame 404 with MorePPDU=1 (816). Note also that even if the primary data for the RD initiator is not ready, the processor 704 may insert other data or commands into the QoS Null frame. This other data is “out of band” in the sense that it is not part of the primary data tracked with sequence information (e.g., with the sequence control field 410). In one implementation, the processor 704 inserts the other data or commands into the sequence control field 412 (818). The endpoint 700 thereby uses the sequence control field 412 for a different purpose other than that originally specified.

The QoS Null frame thus provides a command and data stream back to the RD initiator, even though it has no specific data payload field. Furthermore, the endpoint 700 may signal to the RD initiator that other data or commands are present in the sequence control field 412 (or other field) by using a specific bit pattern in the sequence control field 412 (or other field) agreed upon ahead of time by the RD initiator and the RD responder. The transceiver 702 then transmits the QoS Null frame (820). The endpoint 700 may continue to transmit QoS Null frames, for example until the primary data in the endpoint 700 is ready for the RD initiator.

The processor 704 determines when the primary data is ready in the endpoint 700. At that time, the processor 704 prepares, for example, one or more QoS Data frames 402 (822) and inserts at least a portion of the primary data into the QoS Data frames (824). The processor 704 also sets the continuation bit(s) (e.g., the MorePPDU bit(s)) appropriately (826). For example, when the endpoint 700 has additional data to send, then the processor 704 may set MorePPDU=1; otherwise, the processor may set the MorePPDU bit=0. The transceiver 702 sends the QoS Data frames individually, or aggregated into larger units (e.g., AMPDUs) (828). The endpoint may continue to send QoS Null or QoS Data frames until it has no further primary data to send, or until the RDG time is over.

The endpoint 700 may establish and hold open the reverse direction channel in other ways. For example, in other implementations, the endpoint 700 may communicate a control wrapper frame with an HT control field with MorePPDU set to 1. For example, if the endpoint does not adhere to the WiGig specification, but does adhere to the 802.11 n standard, then the endpoint 700 may hold the reverse channel open using the control wrapper frame instead of a QoS Null frame. In this scenario also, the endpoint 700 may continue to send control wrapper frames in which the MorePPDU bit is set to 1 until the endpoint 700 has data ready to send, or until the endpoint 700 decides to send the data that it has ready. In other words, the control wrapper frame may also act to keep the reverse direction channel open (even though it has no data to send), while the endpoint 700 prepares to send primary data back to the RD initiator.

The methods, devices, and logic described above may be implemented in many different ways in many different combinations of hardware, software or both hardware and software. For example, all or parts of the endpoint 700 may include circuitry in a controller, a microprocessor, or an application specific integrated circuit (ASIC), or may be implemented with discrete logic or components, or a combination of other types of circuitry. All or part of the logic may be implemented as instructions for execution by a processor, controller, or other processing device and may be stored in a machine-readable or computer-readable medium such as flash memory, random access memory (RAM) or read only memory (ROM), flash memory, erasable programmable read only memory (EPROM) or other machine-readable medium such as a compact disc read only memory (CDROM), or magnetic or optical disk.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method for establishing a reverse direction communication channel from a responder to an initiator, the method comprising:
receiving a reverse direction grant indicator at a responder;
determining when primary data is not ready to be sent to the initiator, and in response:
transmitting from the responder to the initiator, within a predetermined response time for establishing the reverse direction communication channel, a continuation frame comprising a continuation indicator that indicates that reverse direction communication channel should persist,
the continuation frame comprising at least one control field including the continuation indicator, but no data payload field.

2. The method of claim 1, where transmitting comprises:
transmitting the continuation frame as an initial response to the reverse direction grant indicator.

3. The method of claim 1, where transmitting comprises:
transmitting an acknowledgement frame immediately followed by the continuation frame as an initial response to the reverse direction grant indicator.

4. The method of claim 1, further comprising:
using an existing field defined for a specific purpose in the continuation frame for communicating other data from the responder to the initiator for a different purpose then the specific purpose.

5. The method of claim 1, where the continuation frame comprises a QoS Null frame.

6. The method of claim 1, where transmitting comprises:
transmitting a series of the continuation frames with the data continuation indicator set, until the responder has the primary data ready to transmit to the initiator.

7. The method of claim 6, further comprising:
transmitting to the initiator a data frame comprising a payload field that includes at least a portion of the primary data.

8. A system comprising:
a receiver in a responder that receives a reverse direction grant indicator sent by an initiator; and
response logic operable to respond to the reverse direction grant indicator by:
determining when primary data is not ready to be sent to the initiator; and in response, initiating transmission from the responder to the initiator, within a predetermined response time for establishing the reverse direction communication channel, of a continuation frame comprising a continuation indicator that indicates that reverse direction communication channel should persist,
the continuation frame comprising at least one control field including the continuation indicator, but no data payload field.

9. The system of claim 8, where:
the continuation frame comprises an initial response to the reverse direction grant indicator.

10. The system of claim 8, where the response logic is operable to respond to the reverse direction grant indicator by:
preparing the continuation frame;
preparing an acknowledgement frame; and
initiating transmission of the acknowledgment frame immediately followed by the continuation frame as an initial response to the reverse direction grant indicator,

11. The system of claim 8, where:
the continuation frame comprises an existing field pre-defined for a specific purpose; and
the response logic is further operable to communicate other data in the existing field from the responder to the initiator for a different purpose than the specific purpose.

12. The system of claim 8, where the continuation frame comprises a QoS Null frame.

13. The system of claim 8, where the response logic is operable to respond to the reverse direction grant indicator by:
initiating transmission of a series of the continuation frames with the data continuation indicator set, until the responder has the primary data ready to transmit to the initiator.

14. The system of claim 9, where the response logic is further operable to respond to the reverse direction grant indicator by:
initiating transmission to the initiator of a data frame comprising a payload field that includes at least a portion of the primary data.

15. A system for managing a reverse direction communication channel from a responder to an initiator, the system comprising:
a receiver that detects a reverse direction grant indicator sent by the initiator to the responder;
a memory that stores the reverse direction grant indicator after it is received;
a processor that executes response logic, the response logic operable to:
determine whether the responder has primary data that is tracked by sequence control information to return to the initiator;
determine whether the responder is ready with the primary data;
when the primary data is not ready:
prepare a continuation frame comprising a continuation indicator; and
set the continuation indicator to indicate that the reverse direction communication channel from the responder to the initiator should persist; and
when the primary data is ready:
prepare a primary data frame comprising at least a portion of the primary data; and
a transmitter that transmits the continuation frame and the primary data frame from the responder to the initiator.

16. The system of claim 15, where the continuation frame comprises a QoS Null frame.

17. The system of claim 15, where the primary data frame comprises a QoS Data frame.

18. The system of claim 15, where the response logic is further operable to:
transmit a sequence of the continuation frames until the primary data is ready.

19. The system of claim 15, where the response logic is further operable to:
identify an existing field in the continuation frame defined for a specific purpose;
insert other data into the existing field for a different purpose other than the specific purpose.

20. The system of claim 15, where the response logic is further operable to:
identify an existing field in the continuation frame defined for a specific purpose;
insert information into the existing field for a different purpose other than the specific purpose, where the information comprises a command for the initiator to execute.
